(19) United States
(12) Patent Application Publication
(10) Pub. No.: US 2024/0303066 A1
(43) Pub. Date: Sep. 12, 2024

(54) SERVER SYSTEM AND FIRMWARE UPDATING METHOD THEREOF

(71) Applicant: MITAC COMPUTING TECHNOLOGY CORPORATION, Taoyuan City (TW)

(72) Inventor: Chia-Hang CHUNG, Taoyuan City (TW)

(73) Assignee: MITAC COMPUTING TECHNOLOGY CORPORATION, Taoyuan City (TW)

(21) Appl. No.: 18/453,805

(22) Filed: Aug. 22, 2023

(30) Foreign Application Priority Data
Mar. 10, 2023 (TW) 112109044

(51) Int. Cl. G06F 8/65

(52) U.S. Cl. CPC G06F 8/65

(57) ABSTRACT

A server system and a firmware updating method thereof are provided. The server system includes a first module and a second module. The first module includes a first logic circuit and a first selection circuit. The second module includes a second logic circuit, a second selection circuit, a control circuit, and a storage circuit. The first selection circuit is configured to select the transmission target of the first logic circuit according to a first control signal. The second selection circuit is configured to select the transmission target of the second logic circuit according to a second control signal. The control circuit is configured to update the firmware of the first logic circuit and the firmware of the second logic circuit. The storage circuit is configured to store a support list having default usage codes, and each of the default usage codes indicates a corresponding one of target devices.

### CROSS-REFERENCE TO RELATED APPLICATION

This non-provisional application claims priority under 35 U.S.C. § 119(a) to patent application Ser. No. 11/210,9044 filed in Taiwan, R.O.C. on Mar. 10, 2023, the entire contents of which are hereby incorporated by reference.

### BACKGROUND

### Technical Field

The present disclosure relates to firmware updating technologies, and particularly relates to a server system and a firmware updating method thereof.

### Related Art

Open compute project (OCP) is a non-profit organization launched in 2011 by technology companies such as Facebook, Intel, etc. The purpose of its establishment is to create the hardware architecture of an open data center so as to improve various characteristics and factors of the hardware, such as efficiency, durability, and scalability. With the diversification of computing power requirements and the continuous evolution of security attack technologies, data centers have gradually increased their requirements for hardware security control and management. Therefore, the OCP proposed the general specification of datacenter secure control module (DC-SCM) so as to realize the modularity of security management units.

After that, the OCP further proposed the general specification of DC-SCM 2.0. A platform system conforming to the general specification of DC-SCM 2.0 (hereinafter referred to as DC-SCM 2.0) includes two complex programmable logic devices (CPLDs), and the DC-SCM 2.0 connects the two CPLDs via low-voltage differential signaling (LVDS) tunneling protocol and interface (LTPI). In contrast, a platform system known to the inventor only includes one CPLD. However, since the DC-SCM 2.0 includes two CPLDs, when the DC-SCM 2.0 receives a firmware image to update the firmware of only one of the CPLDs, the DC-SCM 2.0 cannot directly determine the target device (i.e. CPLD) of the firmware image. That is, each time before updating the firmware of CPLDs of the DC-SCM 2.0, a burning tool needs to be manually inserted into the dedicated communication port of the CPLD to be updated so as to burn the target device (CPLD). Thus, when the wrong communication port is manually determined/inserted, the firmware image may be burned to the wrong CPLD, which may cause the circuit board of the platform where the CPLD is located or the CPLD itself to be burned during the operating process.

### SUMMARY

In order to solve the problem above, one or some embodiments of the present disclosure provides a server system. The server system comprises: a first module comprising: a first logic circuit; and a first selection circuit electrically connected to the first logic circuit and configured to select a transmission target of the first logic circuit according to a first control signal; and a second module comprising: a second logic circuit electrically connected to the first logic circuit; a second selection circuit electrically connected to the second logic circuit and configured to select a transmission target of the second logic circuit according to a second control signal; a control circuit electrically connected to the first selection circuit and the second selection circuit, wherein the control circuit is configured to update a firmware of the first logic circuit and a firmware of the second logic circuit and is configured to generate the first control signal and the second control signal; and a storage circuit electrically connected to the control circuit and configured to store a support list, wherein the support list has default usage codes, each of the default usage codes corresponds to at least one of firmware images, each of the firmware images stores a user code, each of the default usage codes indicates a corresponding one of target devices, and each of the target devices is one of the first logic circuit and the second logic circuit; wherein the control circuit is further configured to read the user code stored in each of the firmware images and is further configured to determine whether each of the firmware images matches any one of the default usage codes in the support list according to the user code.

In some embodiments, the control circuit is further configured to control one of the first selection circuit and the second selection circuit correspondingly according to the corresponding one of the default usage codes matched with the user code.

In some embodiments, each of the default usage codes is configured to indicate a project code for the image version of the corresponding one of the firmware images.

In some embodiments, the project code is configured to indicate a module hardware version, a firmware version, or a module hardware version and a firmware version corresponding to the corresponding one of the target devices burned by the corresponding one of the firmware images.

In some embodiments, the first logic circuit and the second logic circuit have the same product-identification feature.

In some embodiments, the first logic circuit and the second logic circuit have the same manufacturer ID, the same product ID, the same product name, the same product model, or any combination thereof.

In some embodiments, the control circuit is electrically connected to a remote device, and the control circuit is further configured to receive each of the firmware images transmitted by the remote device.

In some embodiments, the first module is a secure control module (SCM), and the second module is a host processor module (HPM).

In some embodiments, the control circuit is electrically connected to the first logic circuit and the second logic circuit via an I2C bus or a JTAG bus.

In some embodiments, the control circuit is further configured to generate the first control signal or the second control signal correspondingly according to the corresponding one of the target devices corresponding to the corresponding one of the default usage codes matched with the user code; wherein the first control signal corresponds to the first logic circuit, and the second control signal corresponds to the second logic circuit.

In some embodiments, the control circuit controls the first logic circuit or the second logic circuit to be electrically connected to the control circuit correspondingly according to the first control signal or the second control signal.

One or some embodiments of the present disclosure also provides a firmware updating method. The firmware updating method comprises: reading a user code stored in a firmware image; determining whether the firmware image matches one of default usage codes in a support list according to the user code; determining a corresponding one of target devices suitable for the firmware image according to the one of the default usage codes matched with the user code if the firmware image matches the one of the default usage codes in the support list, wherein the corresponding one of the target devices is one of a first logic circuit of a first module and a second logic circuit of a second module; and controlling one of a first selection circuit and a second selection circuit correspondingly according to the one of the default usage codes matched with the user code.

In some embodiments, the firmware updating method further comprising: generating a first control signal or a second control signal correspondingly according to the corresponding one of the target devices corresponding to the one of the default usage codes matched with the user code; wherein the first control signal corresponds to the first logic circuit, and the second control signal corresponds to the second logic circuit.

In some embodiments, the firmware updating method further comprising: controlling the first logic circuit or the second logic circuit to be electrically connected to a control circuit correspondingly according to the first control signal or the second control signal generated by the control circuit.

In conclusion, according to some embodiments of the server system, when the server system updates the firmware of the first logic circuit of the first module or the firmware of the second logic circuit of the second module, the server system can directly read the user code stored in the firmware image without parsing the firmware image so as to determine the target device of the firmware image (for example, the target device is one of the first logic circuit and the second logic circuit). Therefore, the firmware image can prevent from being burned to the wrong device which may cause the wrong device to be burned and damaged.

### BRIEF DESCRIPTION OF THE DRAWINGS

FIG. 1 illustrates a module block diagram of a server system according to an embodiment of the present disclosure.

FIG. 2 illustrates a schematic diagram of a low-voltage differential signaling (LVDS) tunneling protocol and interface (LTPI) according to an embodiment of the present disclosure.

FIG. 3 illustrates a schematic circuit diagram of a first selection circuit according to an embodiment of the present disclosure.

FIG. 4 illustrates a schematic circuit diagram of a second selection circuit according to an embodiment of the present disclosure.

FIG. 5 illustrates a schematic diagram of a firmware image according to an embodiment of the present disclosure.

FIG. 6 illustrates a flow chart diagram of the server system according to an embodiment of the present disclosure.

### DETAILED DESCRIPTION

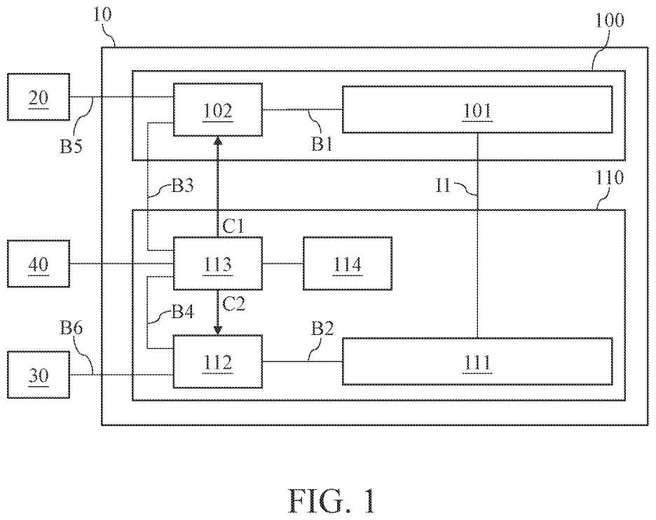

Please refer to FIG. 1. FIG. 1 illustrates a module block diagram of a server system 10 according to an embodiment of the present disclosure. As shown in FIG. 1, the server system 10 includes a first module 100 and a second module 110, wherein the first module 100 includes a first logic circuit 101 and a first selection circuit 102, and the second module 110 includes a second logic circuit 111, a second selection circuit 112, a control circuit 113, and a storage circuit 114. The first selection circuit 102 is electrically connected to the first logic circuit 101, and the second logic circuit 111 is electrically connected to the first logic circuit 101. The second selection circuit 112 is electrically connected to the second logic circuit 111, the control circuit 113 is electrically connected to the first selection circuit 102 and the second selection circuit 112, and the storage circuit 114 is electrically connected to the control circuit 113. The structures, functions, and arrangements of the first logic circuit 101, the first selection circuit 102, the second logic circuit 111, the second selection circuit 112, the control circuit 113, and the storage circuit 114 are explained below respectively.

In some embodiments, the server system 10 conforms to but is not limited to the general specification of DC-SCM 2.0, wherein the first module 100 is a circuit module that can be matched with the second module 110 to expand the function of the server system 10 or increase the performance/efficiency of the server system 10; for example, the first module 100 is a secure control module (SCM), a backplane, a riser card, or the like. The second module is, for example, a host processor module (HPM) or a server motherboard. In other embodiments, the first module 100 is the HPM or the server motherboard, the second module 110 is the SCM, the backplane, the riser card, or the like, and the present disclosure is not limited thereto.

In some embodiments, the first logic circuit 101 and the second logic circuit 111 are elements of the same type, for example, both are complex programmable logic devices (CPLDs), both are field programmable gate arrays (FPGAs), or both are microcontroller units (MCUs), and the present disclosure is not limited thereto. The first logic circuit 101 and the second logic circuit 111 have the same product-identification feature. For example, the first logic circuit 101 and the second logic circuit 111 can install and execute the same firmware. Alternatively, in some embodiments, the first logic circuit 101 and the second logic circuit 111 have the same manufacturer ID, the same product ID, the same product name, the same product model, or any combination thereof.

In some embodiments, the first logic circuit 101 is electrically connected to the second logic circuit 111 via a low-voltage differential signaling (LVDS) tunneling protocol and interface (LTPI), a system management bus (SMBus), or a universal asynchronous receiver/transmitter (UART), but the present disclosure is not limited thereto. The following paragraphs will take the LTPI as an example to explain the connection relationship between the first logic circuit 101 and the second logic circuit 111.

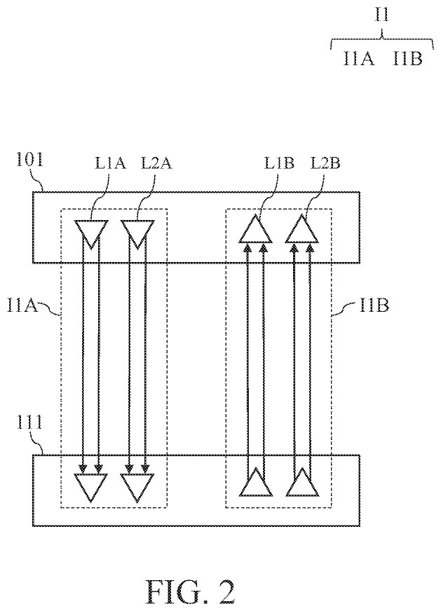

Please refer to FIG. 2. FIG. 2 illustrates a schematic diagram of the LTPI according to an embodiment of the present disclosure. As shown in FIG. 2, in some embodiments, the LTPI (corresponding to a channel interface I1) includes a plurality of general purpose input/output (GPIO) interfaces I1A, I1B. The GPIO interfaces I1A, I1B are interfaces configured to transmit signals and are often applied to various types of development boards (e.g., Raspberry Pi) in the form of pins. The GPIO interfaces I1A, I1B have multiple functions (e.g., input, output, general function, alternate function, etc.), and the GPIO interfaces I1A, I1B can be controlled by software. In some embodiments, the GPIO interface I1A includes a pair of differential links L1B, L2B, the GPIO interface I1B includes a pair of differential links L1B, L2B, wherein each of the differential links LIA, L2A, L1B, L2B includes two pins.

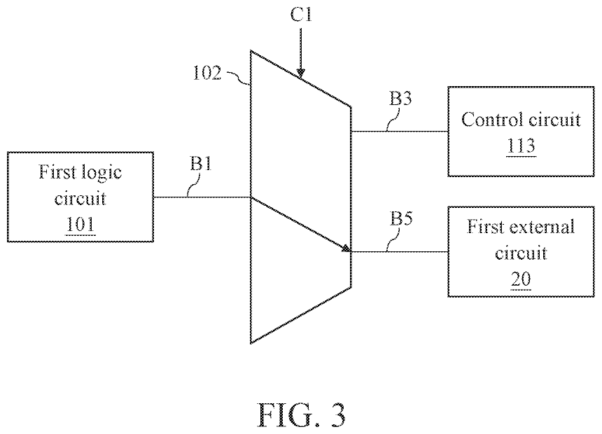

The first selection circuit 102 is configured to select the transmission target of the first logic circuit 101 according to a first control signal C1. Please refer to FIG. 3. FIG. 3 illustrates a schematic circuit diagram of the first selection circuit 102 according to an embodiment of the present disclosure. As shown in FIG. 3, in some embodiments, the first selection circuit 102 is a multiplexer (MUX), wherein the input terminal of the first selection circuit 102 is electrically connected to the first logic circuit 101, one of output terminals of the first selection circuit 102 is electrically connected to the control circuit 113, and the other output terminal of the first selection circuit 102 is electrically connected to a first external circuit 20. In some embodiments, the control circuit 113 generates the first control signal C1 to control the first selection circuit 102 to select the transmission target of the first logic circuit 101. When the first control signal C1 is a first logic level signal, the transmission target of the first logic circuit 101 is the control circuit 113; when the first control signal C1 is a second logic level signal, the transmission target of the first logic circuit 101 is the first external circuit 20. In some embodiments, the first logic level signal is a low voltage logic level signal representing 0, and the second logic level signal is a high logic level signal representing 1. In other embodiments, the first logic level signal is the high logic level signal representing 1, and the second logic level signal is the low voltage logic level signal representing 0.

In some embodiments, the first selection circuit 102 presets the transmission target of the first logic circuit 101 as the first external circuit 20 according to the corresponding first control signal C1, wherein the first external circuit 20 is a server system or another circuit or IC on the first module 100, such as a central processing unit (CPU).

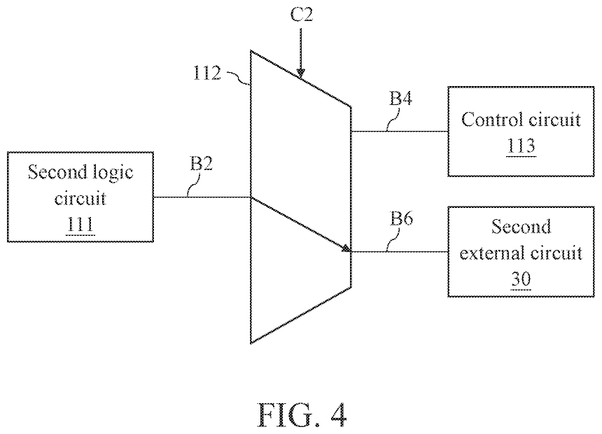

The second selection circuit 112 is configured to select the transmission target of the second logic circuit 111 according to a second control signal C2. Please refer to FIG. 4 FIG. 4 illustrates a schematic circuit diagram of the second selection circuit 112 according to an embodiment of the present disclosure. As shown in FIG. 4, in some embodiments, the second selection circuit 112 is a multiplexer (MUX), wherein the input terminal of the second selection circuit 112 is electrically connected to the second logic circuit 111, one of output terminals of the second selection circuit 112 is electrically connected to the control circuit 113, and the other output terminal of the second selection circuit 112 is electrically connected to a second external circuit 30. In some embodiments, when the second control signal C2 is a third logic level signal, the second selection circuit 112 selects the control circuit 113 as the transmission target of the second logic circuit 111; when the second control signal C2 is a fourth logic level signal, the second selection circuit 112 selects the second external circuit as the transmission target of the second logic circuit 111. In some embodiments, the third logic level signal is a low voltage logic level signal representing 0, and the fourth logic level signal is a high logic level signal representing 1. In other embodiments, the third logic level signal is the high logic level signal representing 1, and the fourth logic level signal is the low voltage logic level signal representing 0.

In some embodiments, the second selection circuit 112 presets the transmission target of the second logic circuit 111 as the second external circuit 30 according to the corresponding second control signal C2, wherein the second external circuit 30 is a server system 10 or another circuit or IC on the second module 110, such as a central processing unit (CPU).

The control circuit 113 is configured to update the firmware of the first logic circuit 101 and the firmware of the second logic circuit 111 and is configured to generate the first control signal C1 and the second control signal C2. In some embodiments, the control circuit 113 is a baseboard management controller (BMC). The BMC is a small processor configured to monitor and manage a host system and is usually located on the motherboard of a computer, a server, a network, or a storage device. In some embodiments, the BMC can execute the monitoring and management functions (such as firmware updating, power management, system temperature monitoring, etc.) on a platform system whether the platform system is in the state of non-booted or booted, so that a remote device can communicate with the BMC via the network for further performing tasks, such as remote monitoring, firmware updating, power management, etc. The state of non-booted or booted of the platform system includes: no matter whether the motherboard provides the operating power required for the operation of the CPU of the platform system after the power supply of the motherboard provides the standby power for booting/operating the BMC; that is, no matter whether the CPU of the platform system starts to operate.

In some embodiments, when the control circuit 113 updates the firmware of the first logic circuit 101, the control circuit 113 has to generate the first control signal C1 correspondingly to control the first selection circuit 102 to select the control circuit 113 as the transmission target of the first logic circuit 101. Therefore, after the control circuit 113 is electronically connected to the first logic circuit 101, the control circuit 113 can update the firmware of the first logic circuit 101. In the same way, when the control circuit 113 updates the firmware of the second logic circuit 111, the control circuit 113 has to generate the corresponding second control signal C2 to control the second selection circuit 112 to select the control circuit 113 as the transmission target of the second logic circuit 111. Therefore, after the control circuit 113 is electronically connected to the second logic circuit 111, the control circuit 113 can update the firmware of the second logic circuit 111.

In some embodiments, the control circuit 113 is electrically connected to the first logic circuit 101 and the second logic circuit 111 via a plurality of buses B1, B2, B3, B4, the first logic circuit 101 is electrically connected to the first external circuit 20 via a plurality of buses B1, B5, and the second logic circuit 111 is electrically connected to the second external circuit 30 via a plurality of buses B2, B6. In some embodiments, buses B1-B6 are inter-integrated circuit (I2C) buses or joint test action group (JTAG) buses, and the present disclosure is not limited thereto. The following paragraphs will take the I2C bus or the JTAG bus as an example to explain the connection relationship between the aforementioned circuits.

The I2C bus is a simple, two-way, and two-wire synchronous serial bus developed by Philips in the 1980s. The characteristic of the I2C bus is that it achieves information transmission between two devices by a clock wire and a data wire, thereby providing a simple and efficient method for the problem of data exchange between devices.

The JTAG bus is a standard (IEEE Std. 1149.1) proposed by institute of electrical and electronics engineers (IEEE). The characteristic of the JTAG bus is that it can access all ICs on a platform system via a plurality of pins. In some embodiments, the plurality of pins include a test data input (TDI) pin, a test data output (TDO) pin, a test clock (TCK) pin, and a test mode select (TMS) pin. In some embodiments, the plurality of pins further includes a test reset (TRST) pin.

Since the I2C bus and the JTAG bus can be controlled by software via their respective pins, the I2C bus and the JTAG bus are suitable for being disposed between the control circuit 113 and the first logic circuit 101 (or the second logic circuit 111), so that the control circuit 113 can update the firmware of the first logic circuit 101 (or the second logic circuit 111) conveniently.

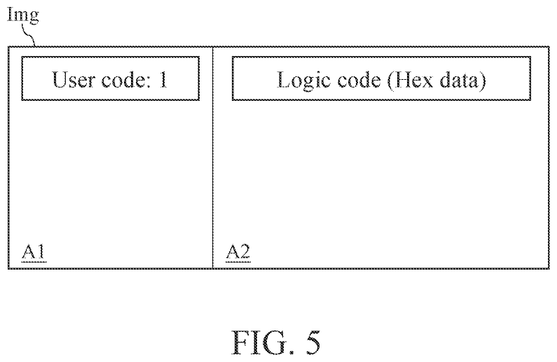

Please refer to FIG. 5. FIG. 5 illustrates a schematic diagram of a firmware image Img according to an embodiment of the present disclosure, wherein the firmware image Img includes an information area A1 and a main program area A2. As shown in FIG. 5, in some embodiments, the information area A1 has information of the firmware image Img and information of the target device corresponding to the firmware image Img, and the main program area A2 has hexadecimal data generated by the logic code of the firmware image Img, wherein data in the information area A1 can be read directly, while data in the main program area A2 can be read and executed by the corresponding target device after being parsed.

In some embodiments, the user code is stored in the information area A1 of the firmware image Img to indicate information of a target device corresponding to the firmware image Img. In other words, in some embodiments, the user code is part of the firmware image Img. Therefore, when the server system 10 receives the firmware image Img, the control circuit 113 of the server system 10 can directly read the user code stored in the information area A1 to analyze which one of the first logic circuit 101 and the second logic circuit 11 is the target device without further parsing the main program area A2 of the firmware image Img. Users do not need to additionally set the control circuit 113 since the version of the firmware image Img is different or the target device to be installed is different.

The storage circuit 114 is configured to store a support list. Please refer to Table 1. Table 1 is a support list stored in the storage circuit 114 according to an embodiment of the present disclosure. The support list has default usage codes, each of the default usage codes corresponds to the user code of the firmware image Img, and each of the default usage codes indicates that the target device to install the firmware image Img is one of the first logic circuit 101 and the second logic circuit 111.

As shown in Table 1, in some embodiments, according to the number of target devices having the same product-identification feature and image versions in the server system 10, the control circuit 113 can support various firmware images Img in the server system 10 to update the firmware of target devices with the same product-identification feature. The following paragraphs will take that the server system 10 supporting 4 types of firmware images Img as an example to explain the server system 10. However, the present disclosure is not limited thereto, and the server system 10 can also support firmware images Img of any number that is more than 2 types depending on actual demands.

In some embodiments, the default usage code is configured to indicate the image version of the firmware image Img. Take Table 1 as an example, the target information of the target device corresponding to the default usage code includes a project code for indicating the image version of the firmware image Img (take a one-digit project code as an example). For example, the project code is Project 1 or Project 2. In the present embodiment, the difference in the image version lies in the firmware version of the firmware image Img. That is, in this embodiment, the difference between Project 1 and Project 2 lies in the firmware version of the firmware image Img.

Therefore, as can be seen from Table 1, in some embodiments, the firmware image Img with the default usage code 1 or 3 can be burned into the first logic circuit 101, wherein the default usage code 1 or 3 indicates that the target device to be installed with the firmware image Img is the first logic circuit 101. In addition, in some embodiments, the firmware image Img with the default usage code 2 or 4 can be burned into the second logic circuit 111, wherein the default usage code 2 or 4 indicates that the target device to be installed with the firmware image Img is the second logic circuit 111. In the same way, the firmware image Img with the default usage code 1 or 3 will not be burned into the second logic circuit 111, and the firmware image Img with the default usage code 2 or 4 will not be burned into the first logic circuit 101.

In some embodiments, the default usage code is configured to indicate the module hardware version of the firmware image Img. Take Table 1 as an example, the target information of the target device corresponding to the default usage code includes the project code for indicating the image version of the firmware image Img. For example, the project code is Project 1 or Project 2. In the present embodiment, the difference in the image version lies in the module hardware version of the firmware image Img. That is, in this embodiment, the difference between Project 1 and Project 2 lies in the module hardware version of the firmware image Img.

Therefore, as can be seen from Table 1, in some embodiments, the firmware image Img with the default usage code 1 can only be burned into the first logic circuit 101 whose module hardware version is Project 1 corresponding to the first module 100, wherein the default usage code 1 indicates that the target device to be installed with the firmware image Img is the first logic circuit 101. In addition, in some embodiments, the firmware image Img with the default usage code 2 can only be burned into the second logic circuit 111 whose module hardware version is Project 1 corresponding to the second module 110, wherein the default usage code 2 indicates that the target device to be installed with the firmware image Img is the second logic circuit 111. In some embodiments, the firmware image Img with the default usage code 3 can only be burned into the first logic circuit 101 whose module hardware version is Project 2 corresponding to the first module 100, wherein the default usage code 3 indicates that the target device to be installed with the firmware image Img is the first logic circuit 101. In addition, in some embodiments, the firmware image Img with the default usage code 4 can only be burned into the second logic circuit 111 whose module hardware version is Project 2 corresponding to the second module 110, wherein the default usage code 4 indicates that the target device to be installed with the firmware image Img is the second logic circuit 111.

TABLE 1

| Target information of target device | Default usage code |
|---|---|
| First logic circuit/Project 1 | 1 |
| Second logic circuit/Project 1 | 2 |
| First logic circuit/Project 2 | 3 |
| Second logic circuit/Project 2 | 4 |

Please refer to Table 2, Table 2 is a support list stored in the storage circuit 114 according to another embodiment of the present disclosure. As shown in Table 2, similar to Table 1, the target information of the target device in Table 2 is configured to indicate that the target device to install the firmware image Img is one of the first logic circuit 101 and the second logic circuit 111. In the present embodiment, the target information of the target device corresponding to the default usage code includes a project code for indicating the image version of the firmware image Img (take a two-digit project code as an example). For example, the project code is Project 11, Project 12, Project 21, or Project 22. In the present embodiment, the difference in the image version lies in the module hardware version of the firmware image Img and the firmware version of the firmware image Img. The following paragraphs will take that the server system 10 supporting 6 types of firmware images Img as an example to explain the server system 10.

In some embodiments, the difference between Project 11, Project 12, Project 21, and Project 22 lies in the module hardware version of the first module 100 (or the second module 110) corresponding to the first logic circuit 101 (or the second logic circuit 111) and the firmware version of the firmware image Img. In some embodiments, Project 11 represents the firmware image Img of the first firmware version of the first logic circuit 101 (or the second logic circuit 111) adapted to the first hardware version of the first module 100 (or the second module 110), and Project 12 represents the firmware image Img of the second firmware version of the first logic circuit 101 (or the second logic circuit 111) adapted to the first hardware version of the first module 100 (or the second module 110). Project 21 represents the firmware image Img of the first firmware version of the first logic circuit 101 (or the second logic circuit 111) adapted to the second hardware version of the first module 100 (or the second module 110), and Project 22 represents the firmware image Img of the second firmware version of the first logic circuit 101 (or the second logic circuit 111) adapted to the second hardware version of the first module 100 (or the second module 110).

Therefore, as can be seen from Table 2, in some embodiments, the firmware image Img with the default usage code 1 or 2 can only be burned into the first logic circuit 101 corresponding to the first module 100 of a first module hardware version, wherein the default usage code 1 or 2 indicates that the target device to be installed with the firmware image Img is the first logic circuit 101. In addition, in some embodiments, the firmware image Img with the default usage code 3 can only be burned into the first logic circuit 101 corresponding to the first module 100 of a second module hardware version, wherein the default usage code 3 indicates that the target device to be installed with the firmware image Img is the first logic circuit 101. In some embodiments, the firmware image Img with the default usage code 4 can only be burned into the second logic circuit 111 corresponding to the second module 110 of a first module hardware version, wherein the default usage code 4 indicates that the target device to be installed with the firmware image Img is the second logic circuit 111. In addition, in some embodiments, the firmware image Img with the default usage code 5 or 6 can only be burned into the second logic circuit 111 corresponding to the second module 110 of a second module hardware version, wherein the default usage code 5 or 6 indicates that the target device to be installed with the firmware image Img is the second logic circuit 111.

TABLE 2

| Target information of target device | Default usage code |
|---|---|
| First logic circuit/Project 11 | 1 |
| First logic circuit/Project 12 | 2 |
| First logic circuit/Project 21 | 3 |
| Second logic circuit/Project 11 | 4 |
| Second logic circuit/Project 21 | 5 |
| Second logic circuit/Project 22 | 6 |

The control circuit 113 is further configured to read the user code stored in the firmware image Img and is further configured to determine whether the firmware image Img matches any one of the default usage codes in the support list according to the user code. When the user code of the firmware image Img read by the control circuit 113 matches any one of the default usage codes in the support list, it indicates that the server system 10 supports the firmware image Img. When the user code of the firmware image Img read by the control circuit 113 does not match any one of the default usage codes in the support list, it indicates that the server system 10 does not support the firmware image Img.

Take FIG. 5 and Table 1 as an example, the user code of the firmware image Img is 1 and a default usage code with a value of 1 also exists in Table 1, which indicates that the server system 10 supports the firmware image Img. At this moment, the control circuit 113 can update the firmware of the first logic circuit 101 (or the second logic circuit 111) through the firmware image Img.

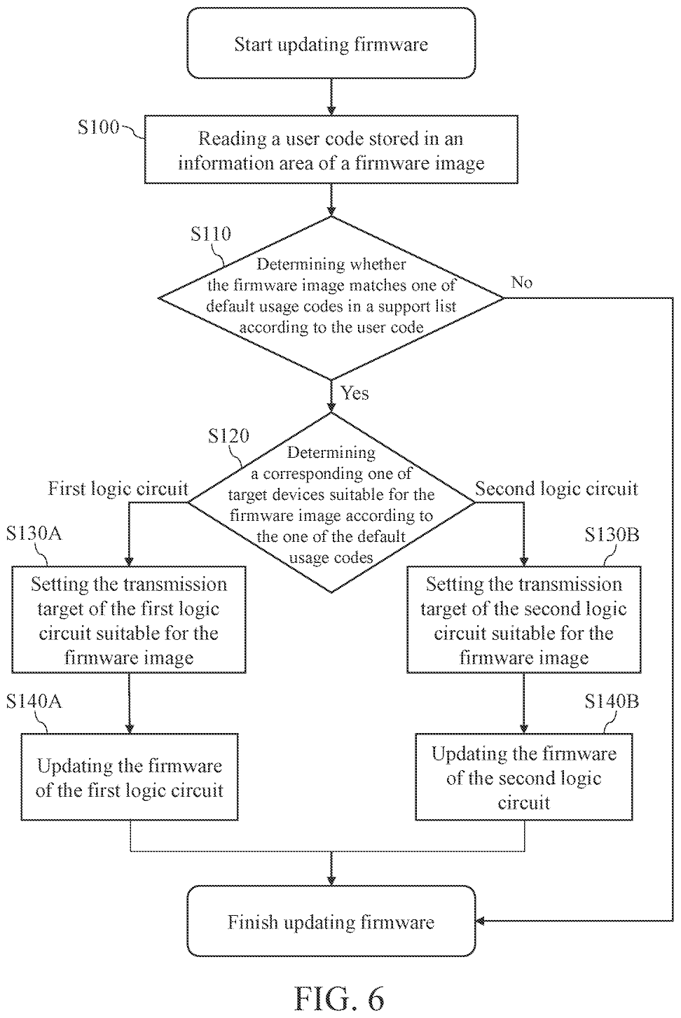

Please refer to FIG. 1 to FIG. 6, FIG. 6 illustrates a flow chart diagram of the server system 10 according to an embodiment of the present disclosure. As shown in FIG. 6, when the server system 10 starts updating the firmware and receives a firmware image Img, the control circuit 113 of the server system 10 reads a user code of the firmware image Img (step S100) and determines whether the firmware image Img matches any one of the default usage codes in a support list according to the user code (step S110). The support list (e.g., Table 1 or Table 2) is stored in the storage circuit 114 of the server system 10.

If the firmware image Img does not match any one of the default usage codes in the support list, it indicates that the server system 10 does not support the firmware image Img. At this moment, the server system 10 finishes updating the firmware to avoid burning the wrong firmware image to a first logic circuit 101 or a second logic circuit 111. If the firmware image Img matches any one of default usage codes in the support list, the server system 10 determines a target device suitable for the firmware image Img according to the default usage code matched with the user code (step S120). In some embodiments, the target device is selected from the first logic circuit 101 or the second logic circuit 111.

In some embodiments, the control circuit 113 also obtains a corresponding actual hardware version of the module corresponding to the target device (the first module 100 or the second module 110) according to the target device, and the control circuit 113 further compares whether the actual hardware version matches the module hardware version indicated by the default usage code. If the actual hardware version does not match the module hardware version indicated by the default usage code, the server system 10 finishes updating the firmware to avoid burning the wrong firmware image to a first logic circuit 101 or a second logic circuit 111.

When the target device is the first logic circuit 101, the control circuit 113 sets the transmission target of the first logic circuit 101 suitable for the firmware image Img (step S130A). At this moment, the first selection circuit 102 of the server system 10 changes the transmission target of the first logic circuit 101 into the control circuit 113 according to the first control signal C1 generated by the control circuit 113 correspondingly. That is, in this embodiment, the control circuit 113 controls the first selection circuit 102 to communicatively connect the first logic circuit 101 and the control circuit 113, so that the control circuit 113 and the first logic circuit 101 can perform data transmission via the first selection circuit 102. Moreover, because the default transmission target is the second external circuit 30, the second selection circuit 112 of the server system 10 will not set the transmission target of the second logic circuit 111 as the control circuit 113. That is, in this embodiment, the second selection circuit 112 does not communicatively connect the control circuit 113 and the second logic circuit 111. Therefore, the control circuit 113 cannot perform data transmission with the second logic circuit 111 via the second selection circuit 112. In some embodiments, the control circuit 113 generates the first control signal C1 correspondingly according to the default usage code matched with the user code. Finally, the control circuit 113 updates the firmware of the first logic circuit 101 via the buses B1, B3 (step S140A) and finishes the process of updating firmware.

When the target device is the second logic circuit 111, the control circuit 113 sets the transmission target of the second logic circuit 111 suitable for the firmware image Img (step S130B). At this moment, the second selection circuit 112 of the server system 10 changes the transmission target of the second logic circuit 111 into the control circuit 113 according to the second control signal C2 generated by the control circuit 113 correspondingly. That is, in this embodiment, the control circuit 113 controls the second selection circuit 112 to communicatively connect the second logic circuit 111 and the control circuit 113, so that the control circuit 113 and the second logic circuit 111 can perform data transmission via the second selection circuit 112. Moreover, because the default transmission target is the first external circuit 20, the first selection circuit 102 of the server system 10 will not set the transmission target of the first logic circuit 101 as the control circuit 113. That is, in this embodiment, the first selection circuit 102 does not communicatively connect the control circuit 113 and the first logic circuit 101. Therefore, the control circuit 113 cannot perform data transmission with the first logic circuit 101 via the first selection circuit 102. In some embodiments, the control circuit 113 generates the second control signal C2 correspondingly according to the default usage code matched with the user code. Finally, the control circuit 113 updates the firmware of the second logic circuit 111 via the buses B2, B4 (step S140B) and finishes the process of updating firmware.

In some embodiments, the control circuit 113 is electrically connected to a remote device 40, and the control circuit 113 is further configured to receive the firmware image Img transmitted by the remote device 40. Wherein, the remote device 40 transmits the firmware image Img to the control circuit 113 via the internet and the communication port of the control circuit 113 and the control circuit 113 stores the received firmware image Img in the storage circuit 114.

In conclusion, according to some embodiments of the server system 10, when the server system 10 updates the firmware of the first logic circuit 101 of the first module 100 or the firmware of the second logic circuit 111 of the second module 110, the server system can directly read the user code stored in the firmware image Img without parsing the firmware image Img so as to determine the target device of the firmware image Img (for example, the target device is one of the first logic circuit 101 and the second logic circuit 111). Therefore, the firmware image Img can prevent from being burned to the wrong device which may cause the wrong device to be burned and damaged.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. A server system comprising:
a first module comprising:
a first logic circuit; and
a first selection circuit electrically connected to the first logic circuit and configured to select a transmission target of the first logic circuit according to a first control signal; and
a second module comprising:
a second logic circuit electrically connected to the first logic circuit;
a second selection circuit electrically connected to the second logic circuit and configured to select a transmission target of the second logic circuit according to a second control signal;
a control circuit electrically connected to the first selection circuit and the second selection circuit, wherein the control circuit is configured to update a firmware of the first logic circuit and a firmware of the second logic circuit and is configured to generate the first control signal and the second control signal; and
a storage circuit electrically connected to the control circuit and configured to store a support list, wherein the support list has default usage codes, each of the default usage codes corresponds to at least one of firmware images, each of the firmware images stores a user code, each of the default usage codes indicates a corresponding one of target devices, and each of the target devices is one of the first logic circuit and the second logic circuit;
wherein the control circuit is further configured to read the user code stored in each of the firmware images and is further configured to determine whether each of the firmware images matches any one of the default usage codes in the support list according to the user code.

2. The server system according to claim 1, wherein the control circuit is further configured to control one of the first selection circuit and the second selection circuit correspondingly according to the corresponding one of the default usage codes matched with the user code.

3. The server system according to claim 1, wherein each of the default usage codes is configured to indicate a project code for the image version of the corresponding one of the firmware images.

4. The server system according to claim 3, wherein the project code is configured to indicate a module hardware version, a firmware version, or a module hardware version and a firmware version corresponding to the corresponding one of the target devices burned by the corresponding one of the firmware images.

5. The server system according to claim 1, wherein the first logic circuit and the second logic circuit have the same product-identification feature.

6. The server system according to claim 5, wherein the first logic circuit and the second logic circuit have the same manufacturer ID, the same product ID, the same product name, the same product model, or any combination thereof.

7. The server system according to claim 1, wherein the control circuit is electrically connected to a remote device, and the control circuit is further configured to receive each of the firmware images transmitted by the remote device.

8. The server system according to claim 1, wherein each of the firmware images includes an information area and a main program area, each of the information areas has information of the corresponding one of the firmware images and information of the corresponding one of the target devices, and the user code is stored in the information area of the corresponding one of the firmware images to indicate the information of the corresponding one of the target devices.

9. The server system according to claim 8, wherein each of the main program areas has hexadecimal data generated by a logic code of the corresponding one of the firmware images;
wherein, data in each of the information areas is capable of being read directly, while data in each of the main program areas is capable of being read and executed by the corresponding one of the target devices after being parsed.

10. The server system according to claim 1, wherein the control circuit is further configured to generate the first control signal or the second control signal correspondingly according to the corresponding one of the target devices corresponding to the corresponding one of the default usage codes matched with the user code;
wherein the first control signal corresponds to the first logic circuit, and the second control signal corresponds to the second logic circuit.

11. The server system according to claim 10, wherein the control circuit controls the first logic circuit or the second logic circuit to be electrically connected to the control circuit correspondingly according to the first control signal or the second control signal.

12. A firmware updating method comprising:
reading a user code stored in a firmware image;
determining whether the firmware image matches one of default usage codes in a support list according to the user code;
determining a corresponding one of target devices suitable for the firmware image according to the one of the default usage codes matched with the user code if the firmware image matches the one of the default usage codes in the support list, wherein the corresponding one of the target devices is one of a first logic circuit of a first module and a second logic circuit of a second module; and
controlling one of a first selection circuit and a second selection circuit correspondingly according to the one of the default usage codes matched with the user code.

13. The firmware updating method according to claim 12, wherein each of the default usage codes is configured to indicate a project code for the image version of the one of the firmware images.

14. The firmware updating method according to claim 13, wherein the project code is configured to indicate a module hardware version, a firmware version, or a module hardware version and a firmware version corresponding to the corresponding one of the target devices burned by the firmware image.

15. The firmware updating method according to claim 12, wherein the first logic circuit and the second logic circuit have the same product-identification feature.

16. The firmware updating method according to claim 15, the first logic circuit and the second logic circuit have the same manufacturer ID, the same product ID, the same product name, the same product model, or any combination thereof.

17. The firmware updating method according to claim 12, wherein each of the firmware images includes an information area and a main program area, each of the information areas has information of the corresponding one of the firmware images and information of the corresponding one of the target devices, and the user code is stored in the information area of the corresponding one of the firmware images to indicate the information of the corresponding one of the target devices.

18. The firmware updating method according to claim 17, wherein each of the main program areas has hexadecimal data generated by a logic code of the corresponding one of the firmware images;
wherein, data in each of the information areas is capable of being read directly, while data in each of the main program areas is capable of being read and executed by the corresponding one of the target devices after being parsed.

19. The firmware updating method according to claim 12, further comprising:
generating a first control signal or a second control signal correspondingly according to the corresponding one of the target devices corresponding to the one of the default usage codes matched with the user code;
wherein the first control signal corresponds to the first logic circuit, and the second control signal corresponds to the second logic circuit.

20. The firmware updating method according to claim 19, further comprising:
controlling the first logic circuit or the second logic circuit to be electrically connected to a control circuit correspondingly according to the first control signal or the second control signal generated by the control circuit.
